(19) United States
(12) Patent Application Publication
(10) Pub. No.: US 2022/0104425 A1
(43) Pub. Date: Apr. 7, 2022

(54) Seeding Attachment for Riding Aerator

(71) Applicant: Stinger Equipment, Inc., LaGrange, KY (US)

(72) Inventor: David Michael Cook, LaGrange, KY (US)

(21) Appl. No.: 17/495,446

(22) Filed: Oct. 6, 2021

Related U.S. Application Data
(60) Provisional application No. 63/088,288, filed on Oct. 6, 2020.

(51) Int. Cl. A01C 7/10; A01C 7/08

(52) U.S. Cl. CPC A01C 7/102; A01C 7/082

(57) ABSTRACT

A seeder to be mounted on a cultivating machine, for example an aerator, the seeder including: a seed box for containing seed; a mixer assembly inside the seed box to mix the seed; a seed gate movable between an open position and a closed position to regulate flow of the seed, where the seed gate is positioned near a cultivating tool when mounted on the cultivating machine and allows seed to be deposited into or in front of an area being cultivated; and where the seed gate is substantially the same width as the cultivating tool when mounted on the cultivating machine.

### BACKGROUND OF THE INVENTION

The most common practice among landscape professionals for thickening turf has been to aerate and “over-seed” a lawn with grass seed. This process may be conventionally accomplished with walk-behind aerators and then using a push spreader to broadcast seed over the lawn. The process of aerating pulls cores (e.g. plugs of turf and soil) from the ground normally 2-3″ below the surface. This process loosens the soil and allows the soil to receive nutrients and water to the root zone of the existing turf. After aerating, an operator would take a push spreader and broadcast seed over the lawn for it to germinate and grow.

Over the years, aerators have evolved from walk-behind models to riding aerators that now do most of the aerating in the professional lawncare industry. With this evolution of faster aerators, spreaders have been attached to the front of aerators to broadcast or drop seeder while the aerator is moving along.

While attaching a spreader to the front of a riding aerator may have increased the ease and efficiency of aerating and overseeding, this process still has significant draw backs. Adding a spreader to the front of an aerator increased the length of the machine, greatly reducing maneuverability and specifically turning. A spreader hanging off the front of a 1,100 lbs. aerator often gets crushed or damaged during transport or daily use because of its location.

Furthermore, a spreader on the front of an aerator may not deliver seed in the ideal location. A lot of the seed ends up in flower beds and driveways wasted. For example, a broadcast spreader may spread seed 8-12 feet wide and a broadcast spread may also require the operator to go over the property an additional time after aerating to apply seed. A frequent customer complaint when this method is used is that grass now growing in flower beds.

Another method is a drop spreader on the front of an aerator. Such a method does not always deliver seed in the correct location. When the aerator turns the seed is delivered to the side, which may not necessary be where the aerator is aerating. This setup also makes it very difficult to evenly cover a property because the seeder is so far from the aerator tines.

In the equipment rental industry, riding aerators are becoming a popular rental item. Most rental stores will not install a seeder on the front of an aerator because they are too easily damaged.

All methods described above may also require the operator to drive the aerator while simultaneously raising and lowering the tines to aerate, while also turning the seed flow on and off manually, and with a spreader hanging two to three feet off the front of the aerator. Trying to control all of these functions while also driving a 1,100 lbs. aerator at 7 mph in a confined space can prove to be too much for many operators. Furthermore, as previously described, in the rental industry, taking a seeding attachment on and off is often not feasible so they are not offered.

Thus, there is a need for a seeding attachment that can be mounted within the footprint of a riding aerator and deliver grass seed directly in front of the aerating tines and within the width of the machine while aerating. There is also a need for the seeder to have the ability to work automatically, turning itself on/off when the aerator is aerating reducing the workload on the operator. An additional need exists for an operator to be able to control the rate of the seed from the operator platform instead of stopping to adjust the seeding apparatus. Still another need exists for the seeding attachment to have a means of disabling the unit easily with minimal effort so equipment rental stores can enable or disable the feature for each rental.

The information included in this Background section of the specification, including any references cited herein and any description or discussion thereof, is included for technical reference purposes only and is not to be regarded subject matter by which the scope of the invention is to be bound.

### SUMMARY OF THE INVENTION

The present application discloses one or more of the features recited in the appended claims and/or the following features which alone or in any combination, may comprise patentable subject matter.

A seeding attachment for a riding aerator that does not increase the overall footprint of the aerator, so the unit is easy to maneuver and transport is described here. Seed may be delivered only within the width of the machine while also delivering seed direction in front or into the tine area where the aerator is pulling cores. The seeding attachment may turn on and off automatically, so it only drops seed when the aerators aerating. The operator may be able to adjust the seed flow while in use by using discrete settings of the seeding attachment. A lock-out function may also be used by equipment rental stores so they can upsell the attachment easily on their riding aerator.

In some aspects, a cultivating machine includes: a frame; an engine; a cultivating tool; a seeder mounted on the frame to dispense seed to an area being cultivated, where the seeding attachment includes: a seed box; a mixer assembly inside the seed box to mix the seed; a seed gate that moves between open and closed positions to regulate flow of the seed; where the seed gate is located near the cultivating tool and allows seed to be deposited into or in front of an area being cultivated; and where the seed gate is a substantially equivalent width to the width of the cultivating tool.

In some implementations, the seeder also includes: an actuator coupled to the seed gate, where the actuator moves the seed gate; and a controller coupled to the actuator, where the controller may adjust a position of the actuator, thereby moving the seed gate. In some such implementations, the controller is further configured to: receive input from a user; and adjust a position of the actuator in response to the input from the user. In other such implementations, the controller is further configured to: receive, from the actuator, closed loop position feedback; and regulate, by the actuator, an amount of seed flowing from the seed gate based on the closed loop position feedback.

In some implementations, the controller is further configured to disable the seeder based on operator input. In some such implementations, the operator input is a code, and the controller may disable the seeder when the code is received.

In some implementations, the controller is coupled to a foot switch of the cultivating machine, and the controller is further configured to: determine, based on actuation of the foot switch, whether the cultivating machine is cultivating soil; and adjust a position of the actuator to enable seeding when it is determined the cultivating machine is cultivating soil.

In some implementations, the cultivating machine is an aerator and the seeder is mounted between an engine of the aerator and an aerator tine assembly. In other implementations, the cultivating machine additionally includes a platform configured to accommodate a user. In some such implementations, the seed box is positioned between the platform and the engine.

In another aspect, a seeder configured to be mounted on a cultivating machine, the seeder including: a seed box for containing seed; a mixer assembly located inside of the seed box to mix the seed; a seed gate that moves between open and closed positions to regulate flow of the seed; where the seed gate is located near the cultivating tool when the seeder is mounted on the cultivating machine and allows seed to be deposited into or in front of an area being cultivated; and where the seed gate has a width substantially equivalent to a width of the cultivating tool.

In some implementations, the seeder additionally includes: an actuator coupled to the seed gate, where the actuator moves the seed gate; and a controller connected to the actuator, the controller being able to adjust a position of the actuator, thereby moving the seed gate. In some implementations, the controller may also receive input from a user; and adjust a position of the actuator in response to the input from the user. In other implementations, the controller may also receive, from the actuator, closed loop position feedback, and regulate, by the actuator, an amount of seed flowing from the seed gate based on the closed loop position feedback. In some implementations, the controller may disable the seeder based on operator input. In other implementations, the controller may be coupled to a foot switch of the cultivating machine, and when connected to the foot switch the controller may also: determine, based on actuation of the foot switch, whether the cultivating machine is cultivating soil; and adjust a position of the actuator to enable seeding when it is determined the cultivating machine is cultivating soil.

In some implementations, the cultivating machine is an aerator and the seeder is configured to be mounted between an engine of the aerator and an aerator tine assembly.

In yet another aspect, a riding aerator includes: a frame; an engine; one or more tine assemblies; a foot switch coupled to the one or more tine assemblies, wherein when the foot switch is actuated by a user the one or more tine assemblies are lowered into an aerating position; a seeder mounted on the frame to dispense seed to an area being aerated, where the seeder includes: a seed box for the seed; a mixer assembly located inside the seed box to mix the seed; a seed gate that moves between open and closed positions to regulate flow of the seed; where the seed gate is located near the one or more tine assemblies and allows seed to be deposited into or in front of an area being aerated; and where the seed gate has a width substantially equivalent to a width of the one or more tine assemblies; an actuator coupled to the seed gate that moves the seed gate; a controller coupled to the actuator and to the foot switch, the controller configured to: determine, based on actuation of the foot switch, whether the one or more tine assemblies have been lowered into the aerating position; and adjust a position of the actuator, thereby moving the seed gate to the open position.

The term “controller” or “processor” is used herein generally to describe various apparatus relating to the operation of the system and the seeding attachment referred to herein. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions.

A processor or controller may be associated with one or more storage media (generically referred to herein as “memory,” e.g., volatile and non-volatile computer memory). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein.

### BRIEF DESCRIPTION OF THE DRAWINGS

In order that the embodiments may be better understood, embodiments of a seeding attachment will now be described by way of examples. These embodiments are not to limit the scope of the claims as other embodiments of an orthopedic brace will become apparent to one having ordinary skill in the art upon reading the instant description. Non-limiting examples of the present embodiments are shown in figures wherein:

FIG. 1 is and isometric view of the seeding attachment.

FIG. 2 is an isometric view of a riding aerator and the seeding attachment.

FIG. 3 is an isometric view of the seeding attachment install on a riding aerator.

FIG. 4 is a cross section view showing the path the seed takes from the seeder to the ground.

FIG. 5 is an isometric view showing the seeder control and the foot switch commonly used to start aerating on a riding aerator.

FIG. 6 is the seeder control showing the individual button to control the seeder.

FIG. 7 is an isometric cross section view of the seeding attachment.

FIG. 8 is an isometric view of the seeding attachment.

FIG. 9 is an isometric lower view of the seeding attachment without the seed chute.

FIG. 10 is an isometric view of the seed chute.

FIG. 11 is an isometric view of the internal seed mixer on the seeder.

FIG. 12 is an isometric view of the seed gate interaction with the seed box.

FIG. 13 is an isometric view of the seed gate and actuator assembly.

FIG. 14 Is an isometric view of the mixer assembly.

FIG. 15 is a block diagram of an example control system for a seeding attachment consistent with some embodiments described herein.

### DETAILED DESCRIPTION OF THE INVENTION

It is to be understood that a seeding attachment is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

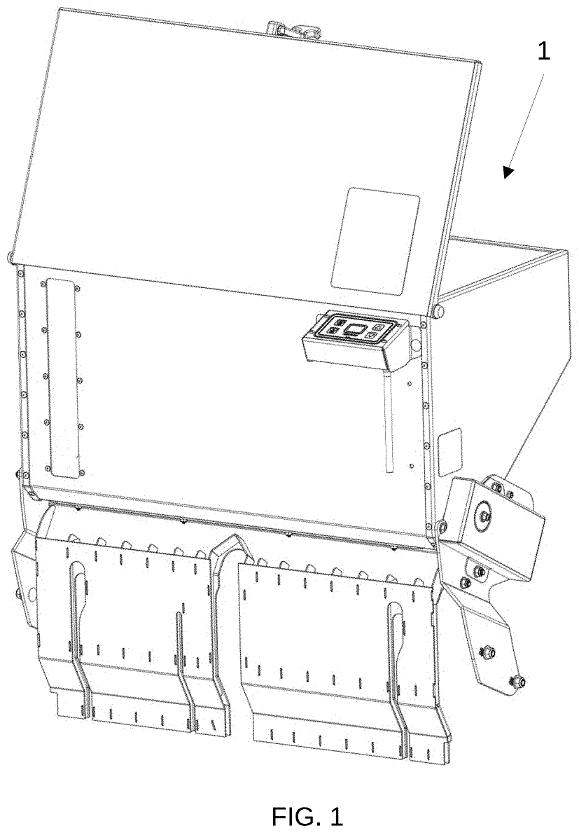

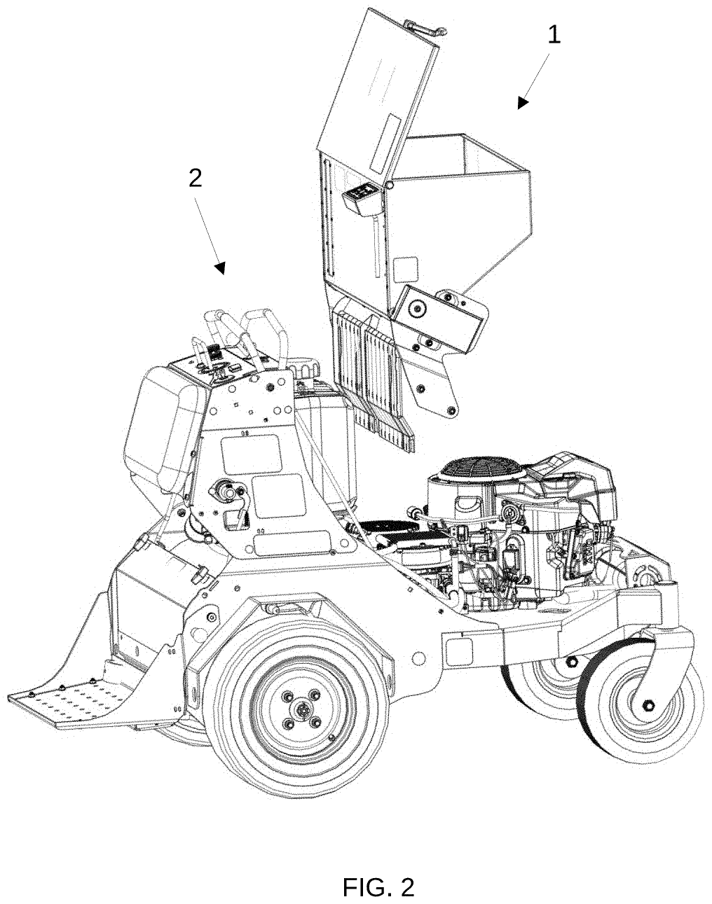

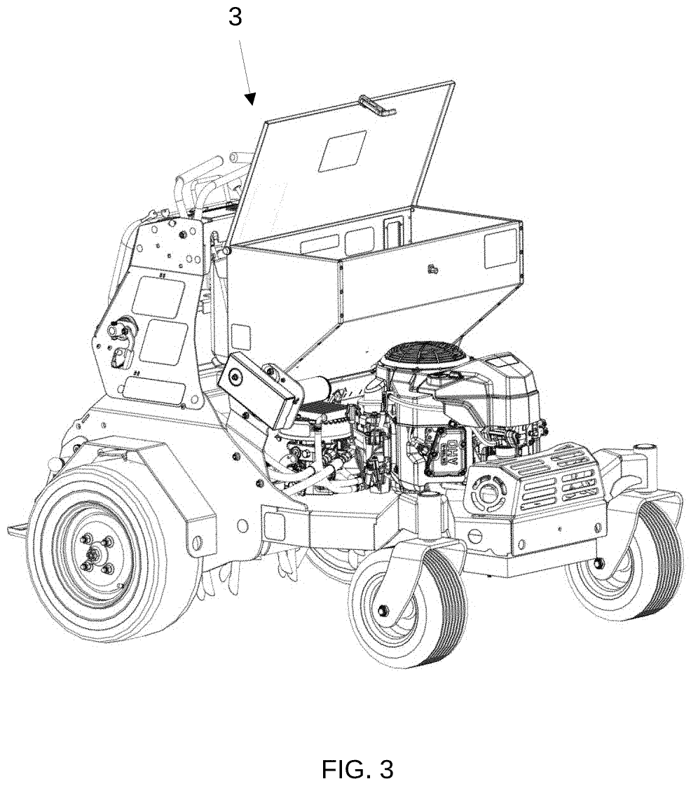

FIG. 1 shows the embodiment of a seeding attachment or seeder 1, in accordance with the present invention. FIG. 2 shows the seeding attachment 1 in relationship to a riding aerator 2. FIG. 3 shows the seeding attachment 1 installed on a riding aerator 2. While illustrated and discussed herein as being attached to an aerator, seeding attachment 1 is not so limited. Other machinery on which seeding attachment 1 may be installed include, but are not limited to, riding slice seeder, riding dethatcher, riding power rake, or any other cultivating machinery known in the art.

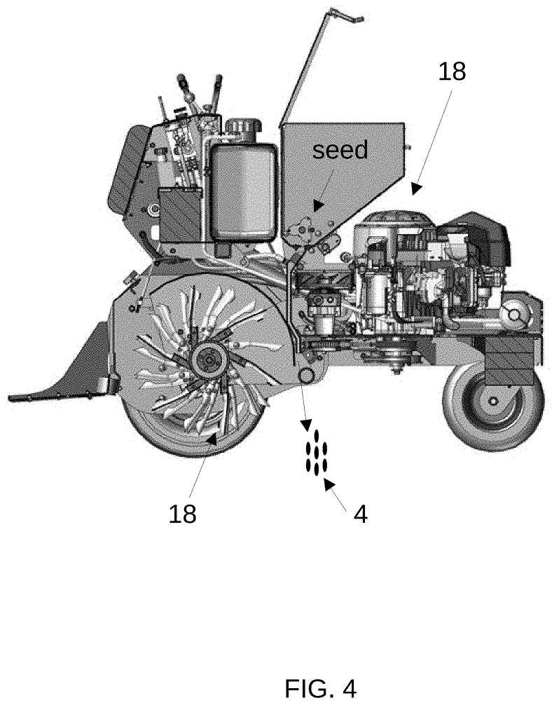

FIG. 4 is a cross section view of the seeding attachment 1 mounted on riding aerator 2. The seeding attachment 1, is mounted between the aerator engine 18 and the aerator tine assembly 19 in such a way as to allow seed to fall as closely as possible to the aerating tines 19. As the aerator is driven and the seed 4 begins to flow from the seed box 12, through the seed chute 14, toward the ground, the seed 4 falls and is blown back into the aerator tine assembly 19 as the machine is driven and mixes with the holes created by the tines and the dirt cores kicked up from the tine action.

The location of the seeding attachment in relation to the aerating tine assembly 19 and the engine 18 allows the aerator to drive and operate the same as if the seeder was not installed on the aerator 2 (e.g. the footprint of the aerator remains the same with or without the seeding attachment 1). Mounting the seeding attachment 1 in the middle of the aerator 2 keeps the aerator balanced and compact so it is much easier to operate than and aerator with a spreader mounted on the front of the aerator. The seeding attachment 1 may be removably coupled with the aerator 2 via one or more bolts, as illustrated in FIGS. 1 and 3. Additionally, the seeding attachment 1 is able to deliver the seed 4 directly into the tine area keeping seed flowing only where the operator intends for the seed to land.

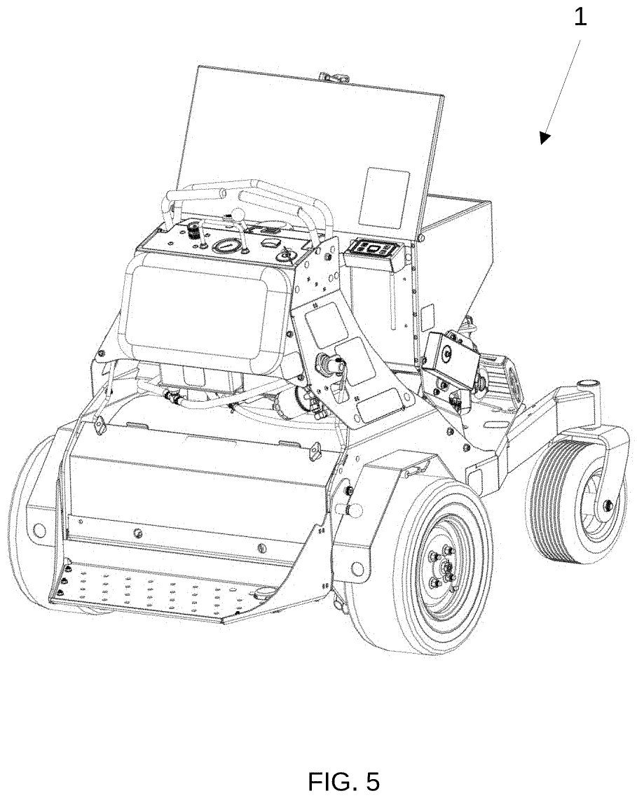

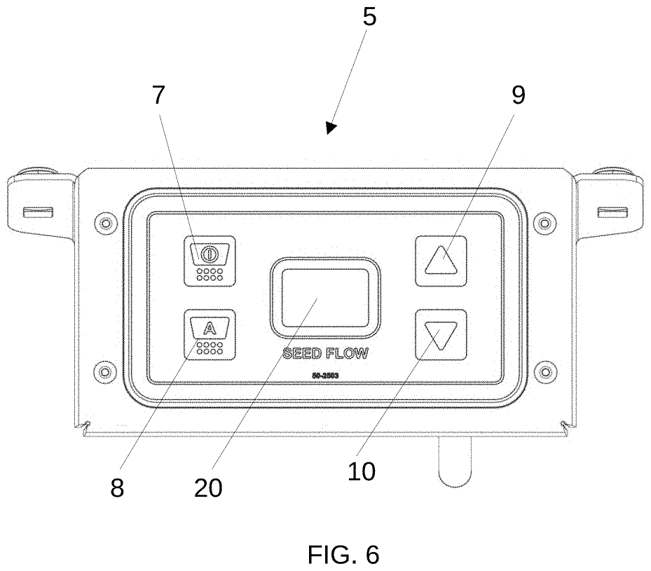

FIGS. 5-6 show a control interface 5 for the seeding attachment 1, and the foot switch 6 used on this riding aerator 2 to start aerating. FIG. 6 shows just the control interface 5 used for the seeding attachment. The on/off button 7, is used to turn the seeding attachment 1 on and off manually. The up arrow 9 and the down arrow 10 may be used to increase manually or decrease the seed flow rate incrementally. The seeder display 20 shows the seed rate in a 0-50 scale which can be incrementally changed by the operator at any time by pressing the up arrow 9, or the down arrow 10 buttons. The automatic button 8, allows the operator to use the seeding attachment 1 in an automatic mode. In the automatic mode, the seeder automatically turns the seed flow on and off only when the aerator 2 is aerating reducing the workload on the operator. When in this automatic mode, the rate of the seed release may also be determined by an operator, through use of the up arrow 9 or down arrow 10. In this example, the operator presses the foot switch 6 to lower the tine assembly 19 and begin aerating. The seeder control senses the 12v signal the foot switch send to the aerator to lower the tines and automatically starts seeding. When the 12v signal stops, the seeding attachment automatically stops seeding.

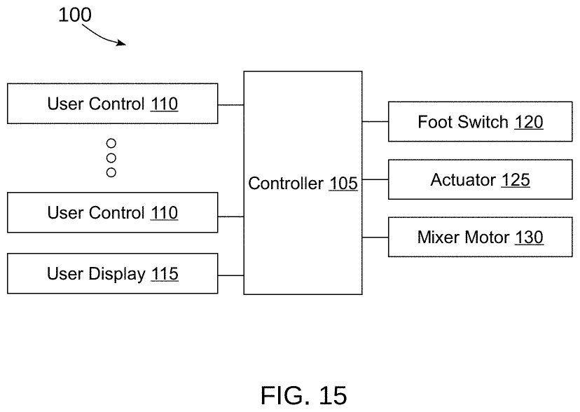

FIG. 15 is a block diagram of an example control system 100 for the seeding attachment 1 consistent with some embodiments described herein. As shown in FIG. 15, the controller 105 may be interfaced with various components, including various user controls 110 for receiving user input (e.g., various combinations of switches, knobs, buttons, sliders, touchscreens or touch-sensitive displays, microphones or audio input devices, image capture devices, etc.). Such user controls may include, but not be limited to, on/off button 7, up arrow 9, down arrow 10, and/or automatic button 8 of FIG. 6. The controller 105 may also be interfaced with a user display 115 (including various indicators, graphical displays, textual displays, speakers, etc.), such as, for example, display screen 20 illustrated in FIG. 6. The controller 105 may also be interfaced with a controller of the cultivating machine to which the seeding attachment is coupled, for example the foot switch 120 described with reference to FIG. 6.

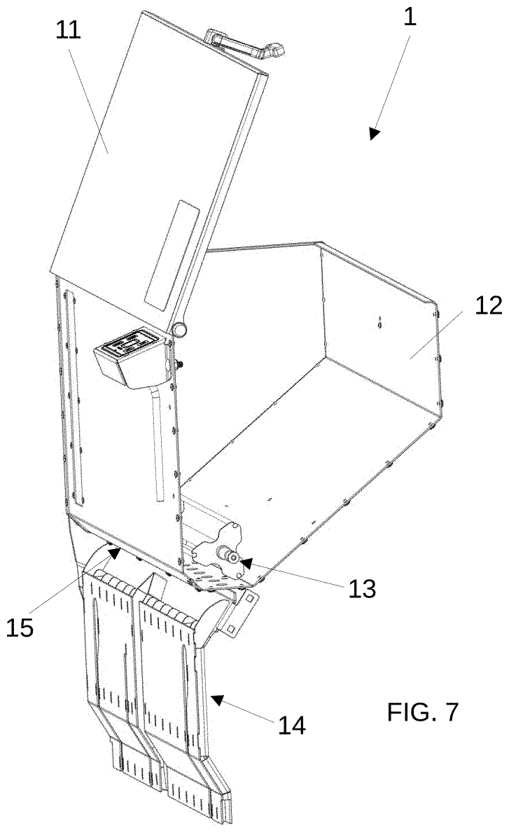

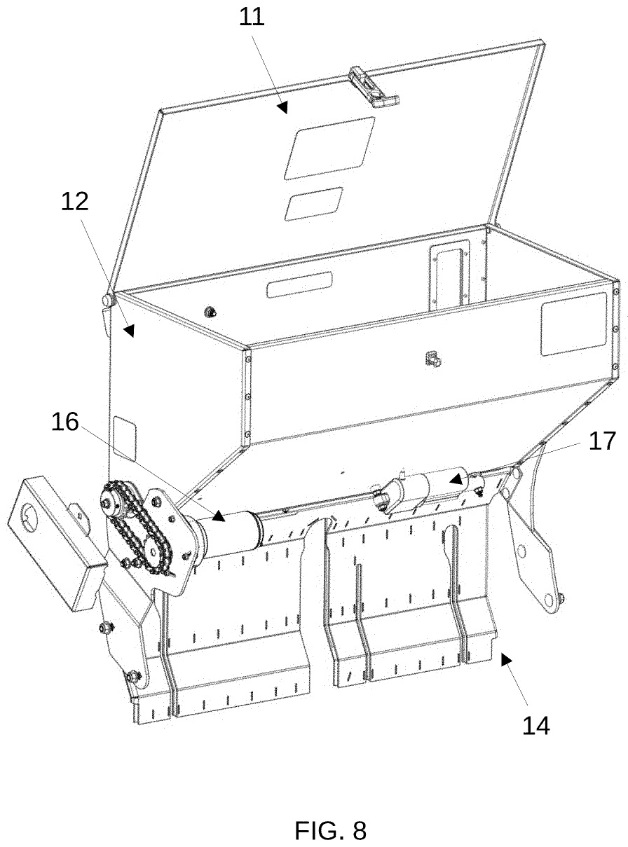

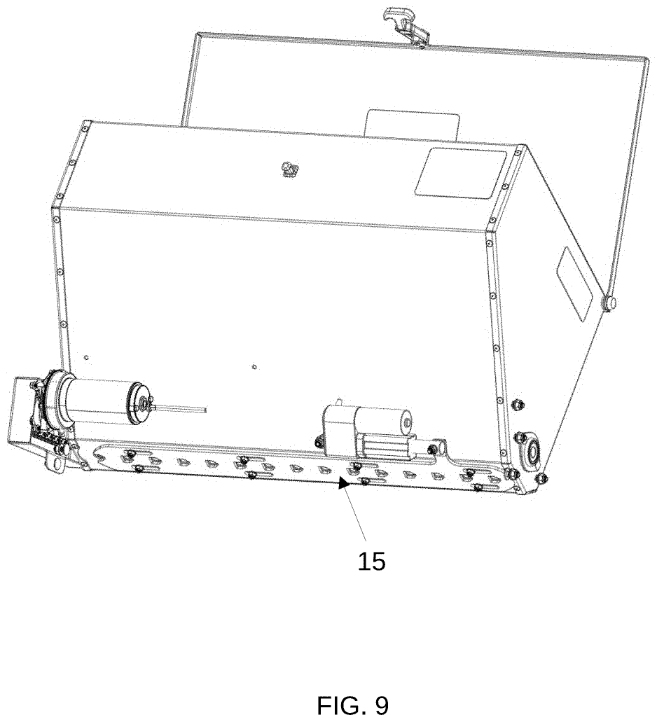

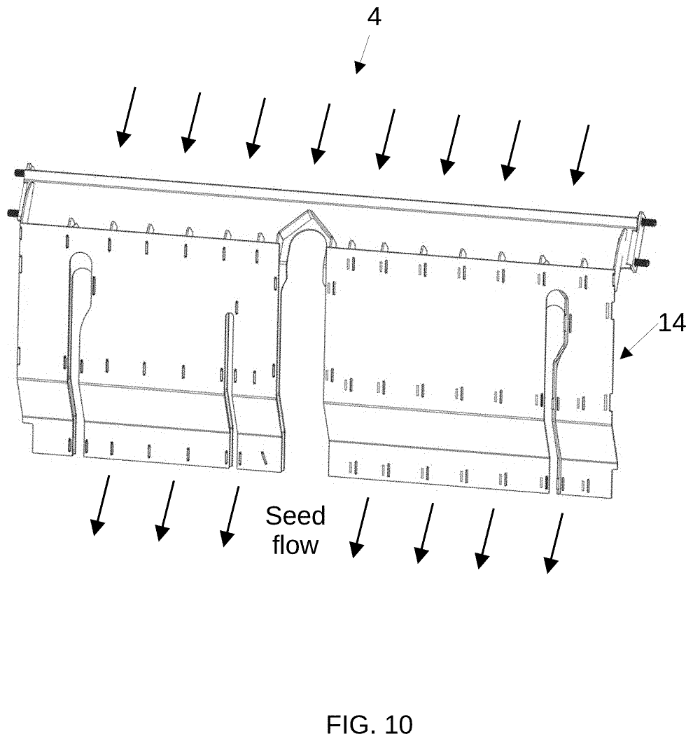

Controller 105 may also be interfaced with an electronic actuator 125 for a seed gate and/or directly to a seed gate. As a non-limiting example, electronic actuator 17 described herein with reference to FIGS. 7-10 may be coupled to controller 105. In such an instance, as described in detail herein, the electronic actuator may provide feedback to controller 105 so that the controller 105 may regulate the amount of seed flowing from the seed box. In some implementations, the controller 105 may further interface with a motor that drives a mixer 130, such as mixer motor 16 illustrated in FIGS. 7-10.

While described herein primarily as a controller, control of the actuator is not to be understood as limiting. Control of the actuator and/or other components of the seeder may also be accomplished through one or more physical components (e.g. cables, chains, etc.) either alone or in combination with a controller.

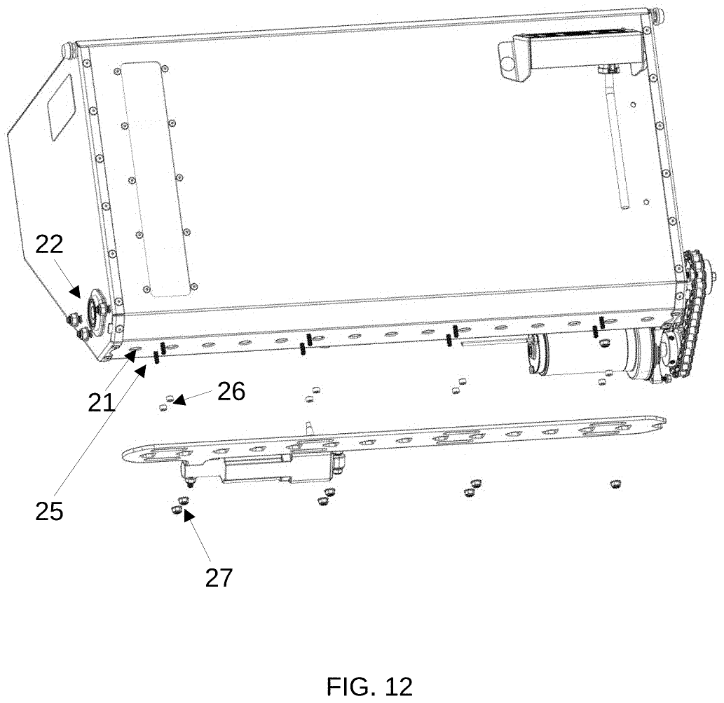

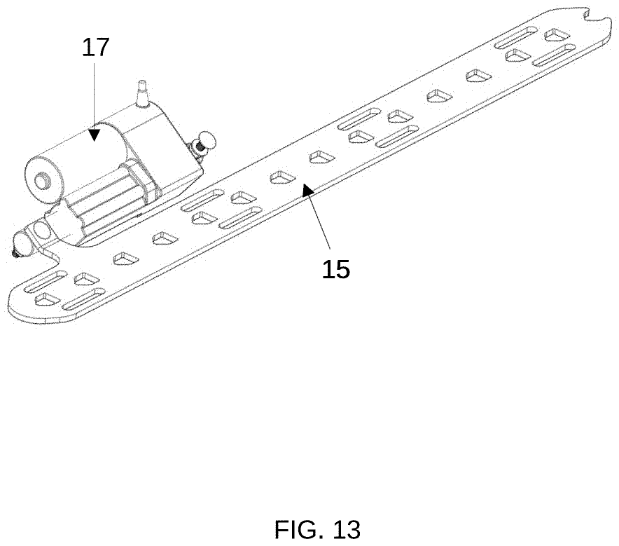

FIGS. 7-10 show the interworking of the seeding attachment 1. The seeding attachment consists of a seed box 12 that hold approximately 60 lbs. of seed. The seeder uses a mixer assembly 13 that mixes the seed when the seeder is activated using mixer motor 16. This mixer assembly 13 may be a paddle, auger, or the like that facilitates movement, and thus mixing of the seed contained within the seed box 12. The mixer motor 16 is connected to the mixer 13 output shaft using a chain drive as shown. The electronic actuator 17 is attached to the seed gate 15. The actuator provides closed loop position feedback to the seed control allowing the seeder controller to regulate how much seed flows from the seed box. The seed gate 15 may contain a plurality of openings that may correspond to openings in the seeding attachment 1 (see FIGS. 12-13). As the actuator 17 moves in and out, the controller 105 can determine the actuator position and adjust accordingly based on a varying resistance output provided by the actuator 17. When the seeder needs to start dropping seed, the actuator 17 opens to a position controlled by the controller 105 based on the input from the operator via control interface 5. The seed gate 15 slides and open small holes in the bottom of the seed box which drops seed into the seed chute 14. The seed 4 flows down the seed chute 14 to the ground as close as possible to the tine assembly 19. When the seed flow needs to stop, the controller 105 reverses the voltage to the actuator 17 closing the actuator 17 which is attached to the seed gate 15 stopping the flow of seed 4.

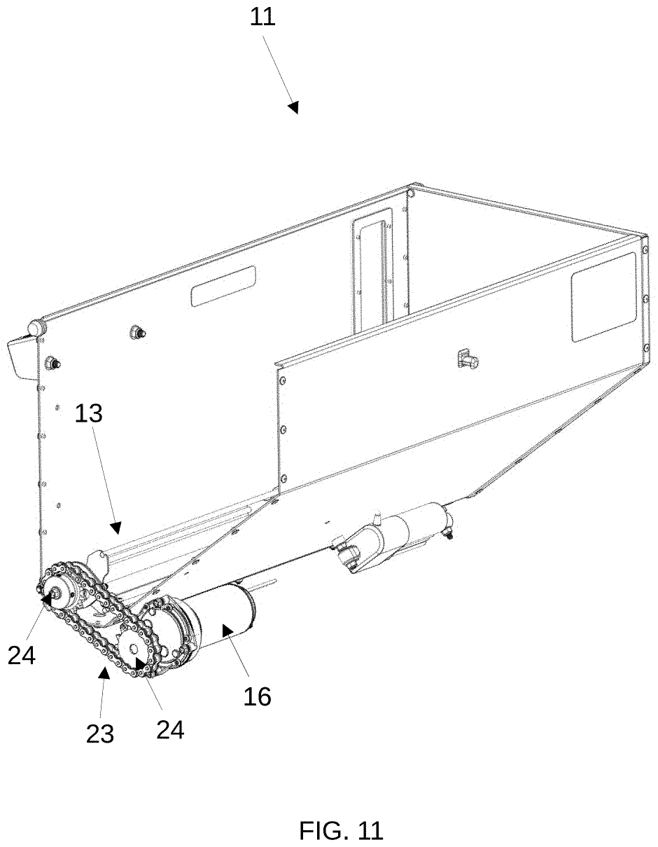

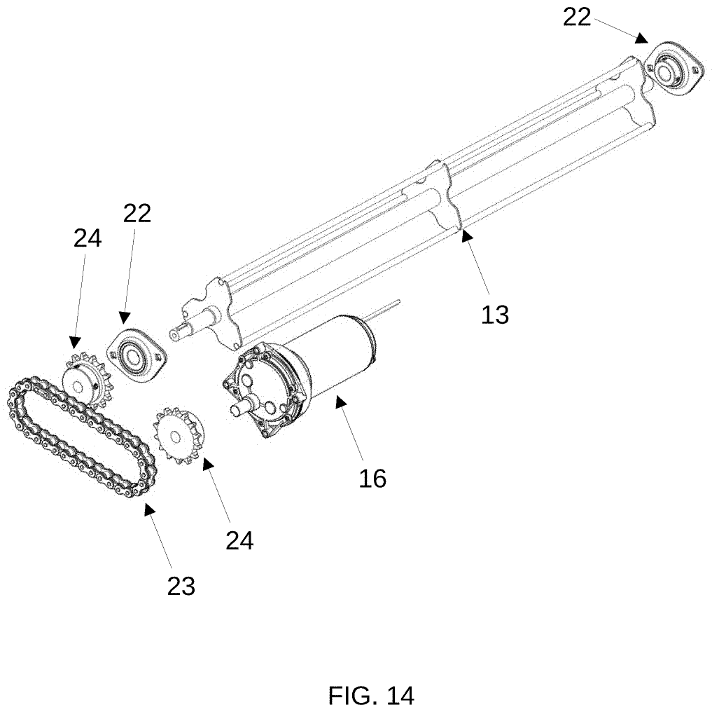

FIGS. 11-14 shows the internal workings of the seeding attachment. FIG. 11 shows the seed mixer 13 installed inside the seed box 12. The mixer rotates on two bearings 22, one on each end of the mixer 13. There are two sprockets 24 that connect the mixer 13 and the mixer motor 16 using a chain 23 allowing the mixer motor 16 to rotate and mix the seed 4 in the seed box 12. FIG. 4 also shows more detail of the mixer 13 and mixer motor 16 interaction.

FIGS. 12-13 shows the interaction of the seed gate 15 and the seed box 12. The seed gate 15 slides side to side along the slot in the seed gate 15 aligned with the 8 bolts 25 and the nylon spacers 26. The seed gate 15 is held in place with the 8 nuts 27.

Additionally, the control interface 5 of the seeder, and thus the seeder itself, is capable of being disabled by an operator to prevent its use. This may desirable, for example, where the seeder is attached to a piece of rental equipment, but may require an additional fee to access. If a renter did not pay the additional fee to obtain access to the seeder, it may be desirable to disable the control interface 5. Disabling the control interface 5 may be accomplished, for example, by programming and using a code to lock/unlock the control interface 5 for use. As a non-limiting example, to disable the control interface 5 of FIG. 6, an operator may first create their own custom lock-out code, which may be accomplished by doing the following within 10 seconds: press and hold Auto button 8 then press up 9, down 10, up 9, down 10, up 9, down 10, down 10. The screen 20 may then show “SC”. The user may then enter a custom code from 2-8 button presses but the last button press cannot be the On/Off button 7. After entering the code, the user presses and holds the on/off button 7 for 2 seconds. The control interface 5 is now locked.

Once programmed with a code, the control interface 5 may be enabled or disabled (e.g. the lock out feature). To activate this feature, the user may press and hold the Auto button 7 for 7 seconds and then “EC” (Enter Code) will be displayed on the screen 20. The user will now enter their custom code (created as described above) follow by pressing on/off 7 and the controller will switch modes from disabled to enabled or enabled to disabled. A user may also erase the custom code created, if desired, by pressing and holding Auto 8 and within 5 seconds also pressing up 9, down 10, up 9, down 10, up 9, down 10, down 10. The control will display CC (Clear Code). Enter the current custom code and the code is now cleared.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto

1. A cultivating machine, comprising:
a frame;
an engine;
a cultivating tool;
a seeder mounted on the frame and configured to dispense seed to an area being cultivated, wherein the seeder includes:
a seed box for containing the seed;
a mixer assembly disposed within the seed box to mix the seed;
a seed gate movable between an open position and a closed position to regulate flow of the seed;
wherein the seed gate is disposed proximate the cultivating tool and is configured to allow seed to be deposited into or in front of an area being cultivated; and
wherein the seed gate has a width substantially equivalent to a width of the cultivating tool.

2. The cultivating machine of claim 1, wherein the seeder further comprises:
an actuator coupled to the seed gate, wherein the actuator moves the seed gate;
a control coupled to the actuator, the control configured to adjust a position of the actuator, thereby moving the seed gate.

3. The cultivating machine of claim 2, wherein the control is further configured to:
receive input from a user;
adjust a position of the actuator in response to the input from the user.

4. The cultivating machine of claim 2, wherein the control is further configured to:
receive, from the actuator, closed loop position feedback; and
regulate, by the actuator, an amount of seed flowing from the seed gate based on the closed loop position feedback.

5. The cultivating machine of claim 2, wherein the control is further configured to disable the seeder based on operator input.

6. The cultivating machine of claim 5, wherein the operator input is a code, and the control is further configured to disable the seeder when the code is received.

7. The cultivating machine of claim 2, wherein the control is coupled to a foot switch of the cultivating machine, and the control is further configured to:
determine, based on actuation of the foot switch, whether the cultivating machine is cultivating soil; and
adjust a position of the actuator to enable seeding when it is determined the cultivating machine is cultivating soil.

8. The cultivating machine of claim 1, wherein the cultivating machine is an aerator, and the seeder is mounted between an engine of the aerator and an aerator tine assembly.

9. The cultivating machine of claim 1 further comprising a platform configured to accommodate a user.

10. The cultivating machine of claim 9, wherein the seed box for containing seed is disposed between the platform and the engine.

11. A seeder configured to be mounted on a cultivating machine, the seeder comprising:
a seed box for containing seed;
a mixer assembly disposed within the seed box to mix the seed;
a seed gate movable between an open position and a closed position to regulate flow of the seed;
wherein the seed gate is disposed proximate a cultivating tool when mounted on the cultivating machine and is configured to allow seed to be deposited into or in front of an area being cultivated; and
wherein the seed gate has a width substantially equivalent to a width of the cultivating tool when mounted on the cultivating machine.

12. The seeder of claim 11, wherein the seeder further comprises:
an actuator coupled to the seed gate, wherein the actuator moves the seed gate;
a control coupled to the actuator, the control configured to adjust a position of the actuator, thereby moving the seed gate.

13. The seeder of claim 12, wherein the control is further configured to:
receive input from a user; and
adjust a position of the actuator in response to the input from the user.

14. The seeder of claim 12, wherein the control is further configured to:
receive, from the actuator, closed loop position feedback; and
regulate, by the actuator, an amount of seed flowing from the seed gate based on the closed loop position feedback.

15. The seeder of claim 12, wherein the control is further configured to disable the seeder based on operator input.

16. The seeder of claim 12, wherein the control is configured to couple to a foot switch of the cultivating machine, and when connected to the foot switch the control is further configured to:
determine, based on actuation of the foot switch, whether the cultivating machine is cultivating soil; and
adjust a position of the actuator to enable seeding when it is determined the cultivating machine is cultivating soil.

17. The seeder of claim 11, wherein the cultivating machine is an aerator and the seeder is configured to be mounted between an engine of the aerator and an aerator tine assembly.

18. A riding aerator comprising:
a frame;
an engine;
one or more tine assemblies;
a foot switch coupled to the one or more tine assemblies, wherein when the foot switch is actuated by a user the one or more tine assemblies are lowered into an aerating position;
a seeder mounted on the frame and configured to dispense seed to an area being aerated, wherein the seeder includes:
a seed box for containing the seed;
a mixer assembly disposed within the seed box to mix the seed;
a seed gate movable between an open position and a closed position to regulate flow of the seed;
wherein the seed gate is disposed proximate the one or more tine assemblies and is configured to allow seed to be deposited into or in front of an area being aerated; and
wherein the seed gate has a width substantially equivalent to a width of the one or more tine assemblies;
an actuator coupled to the seed gate, wherein the actuator moves the seed gate;
a controller coupled to the actuator and to the foot switch, the controller configured to:
determine, based on actuation of the foot switch, whether the one or more tine assemblies have been lowered into the aerating position; and
adjust a position of the actuator, thereby moving the seed gate to the open position.
